(19) United States
(12) Patent Application Publication
(10) Pub. No.: US 2026/0208979 A1
(43) Pub. Date: Jul. 23, 2026

(54) POSITION DETECTOR AND LINEAR CONVEYANCE SYSTEM

(71) Applicant: Mitsubishi Electric Corporation, Tokyo (JP)

(72) Inventors: Yoshinao TATEI, Tokyo (JP); Hisanori TORII, Tokyo (JP); Takeshi MUSHA, Tokyo (JP); Masanori SEKI, Tokyo (JP); Kuya SUZUKI, Tokyo (JP)

(73) Assignee: Mitsubishi Electric Corporation, Tokyo (JP)

(21) Appl. No.: 19/142,654

(22) PCT Filed: Jun. 22, 2023
(86) PCT No.: PCT/JP2023/023206

§ 371 Date: Jun. 24, 2025

(51) Int. Cl. B65G 54/02

(52) U.S. Cl. CPC B65G 54/02; B65G 2203/0283; B65G 2203/043

(57) ABSTRACT

A position detector includes a position detection-specific magnet installable on a mover that moves along a conveyance path including a stator; a position detection unit installable on the conveyance path to detect a magnetic field generated by the position detection-specific magnet; a plurality of magnetic shielding members arrangeable and installable with a gap in a first direction that is a direction of movement of the mover along the conveyance path and capable of providing a shield against magnetic flux heading from a moving magnet of the mover and coils of the stator to the position detection unit; and a gap-specific magnetic shielding member closing the gap between adjacent ones of the magnetic shielding members, the gap-specific magnetic shielding member being capable of providing a shield against the magnetic flux.

### FIELD

The present disclosure relates to a position detector that detects a mover position and a linear conveyance system.

### BACKGROUND

A conventionally known linear servomotor includes a mover and a stator. The mover is configured to include a base and a moving magnet attached to the base for generating a magnetic field for movement of the mover. The stator is configured to include a stator core and a coil attached to the stator core for generating a magnetic field for movement of the mover. In the linear servomotor, the coil of the stator generates the magnetic field when energized. This magnetic field causes propulsive force, thereby moving the mover. The linear servomotor is installed in systems such as linear conveyance systems for conveying articles.

The linear conveyance systems equipped with the linear servomotor generally use a magnetic position detector that detects the position of the mover. The position detector includes a position detection-specific magnet installed on the mover for generating a magnetic field for the position detection and a position detection unit that detects the magnetic field generated by the position detection-specific magnet.

When magnetic flux generated by the moving magnet and the coil interferes with the position detection unit, the position detector fails to accurately detect the magnetic field generated by the position detection-specific magnet, resulting in the problem of deteriorated accuracy of the detection of the mover.

Such a problem is reduced by a technique disclosed in Patent Literature 1. For the disclosed technique, a magnetic shielding member disposed between a stator and position detection units serves as a shield against magnetic flux heading from coils to the position detection units.

### CITATION LIST

### Patent Literature

Patent Literature 1: PCT International Publication No. 2021/124439

### SUMMARY OF INVENTION

### Problem to be solved by the Invention

Where the mover moves a long distance as found in a linear conveyance system, it is necessary to provide a stator and a magnetic shielding member each divided into plural parts, and arrange and install the plural stators in a conveyance direction in assembling the linear conveyance system. Even when the plural magnetic shielding members are arranged and installed without gaps, a gap occurs between adjacent ones of the magnetic shielding members because of inevitable dimensional and assembly tolerances, etc. The magnetic flux generated by the moving magnet and the coil heads toward the position detection unit through the gap and, as a result, interferes with the position detection unit. For this reason, the technique disclosed in Patent Literature 1 has room for improvement in enhancing the accuracy of mover position detection.

The present disclosure has been made in view of the above, and an object of the present disclosure is to obtain a position detector capable of restraining magnetic flux generated by a moving magnet and coils from interfering with a position detection unit through a gap and improving its accuracy of mover position detection compared to a conventional one.

### Means to Solve the Problem

To solve the above problem and achieve the object, a position detector according to the present disclosure comprises: a position detection-specific magnet installable on a mover to move along a conveyance path including a stator; and a position detection unit installable on the conveyance path to detect a magnetic field generated by the position detection-specific magnet. The position detector according to the present disclosure further comprises a plurality of magnetic shielding members arrangeable and installable with a gap in a first direction that is a direction of movement of the mover along the conveyance path, the magnetic shielding members being capable of providing a shield against magnetic flux heading from a moving magnet of the mover and coils of the stator to the position detection unit; and a gap-specific magnetic shielding member closing the gap between adjacent ones of the magnetic shielding members, the gap-specific magnetic shielding member being capable of providing a shield against the magnetic flux.

### EFFECTS OF THE INVENTION

The position detector according to the present disclosure has effects of restraining the magnetic flux generated by the moving magnet and the coils from interfering with the position detection unit through the gap and improving its accuracy of mover position detection compared to a conventional one.

### BRIEF DESCRIPTION OF DRAWINGS

FIG. 1 is a plan view illustrating an entire linear conveyance system according to a first embodiment.

FIG. 2 is a sectional view illustrating the linear conveyance system according to the first embodiment.

FIG. 3 is a plan view illustrating the linear conveyance system according to the first embodiment.

FIG. 4 is a side view illustrating the linear conveyance system according to the first embodiment.

FIG. 5 is an explanatory diagram illustrating an effect of the linear conveyance system according to the first embodiment.

FIG. 6 is a side view illustrating a linear conveyance system according to a second embodiment.

FIG. 7 is a side view illustrating a linear conveyance system according to a third embodiment.

FIG. 8 is a side view illustrating a linear conveyance system according to a fourth embodiment.

FIG. 9 is a side view illustrating a linear conveyance system according to a fifth embodiment.

FIG. 10 is a side view illustrating a linear conveyance system according to a sixth embodiment.

### DESCRIPTION OF EMBODIMENTS

With reference to the drawings, a detailed description is hereinafter provided of position detectors and linear conveyance systems according to embodiments.

### First Embodiment

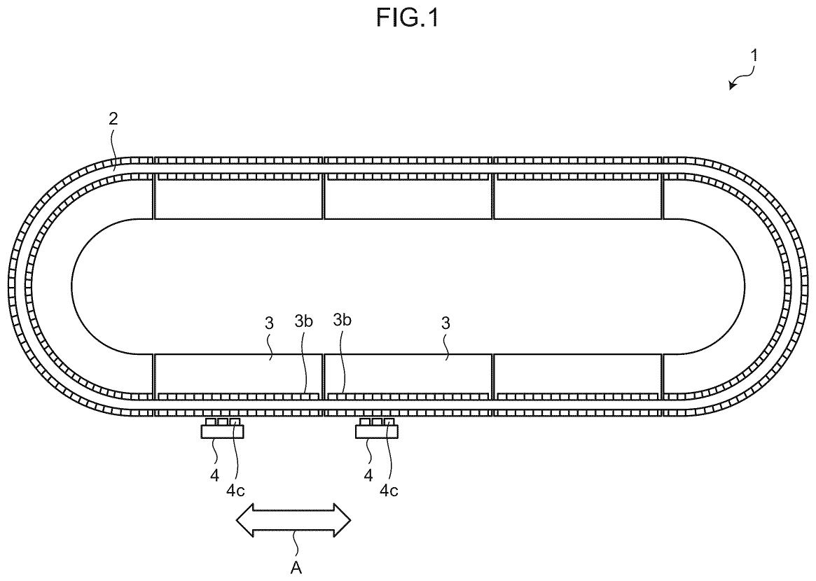

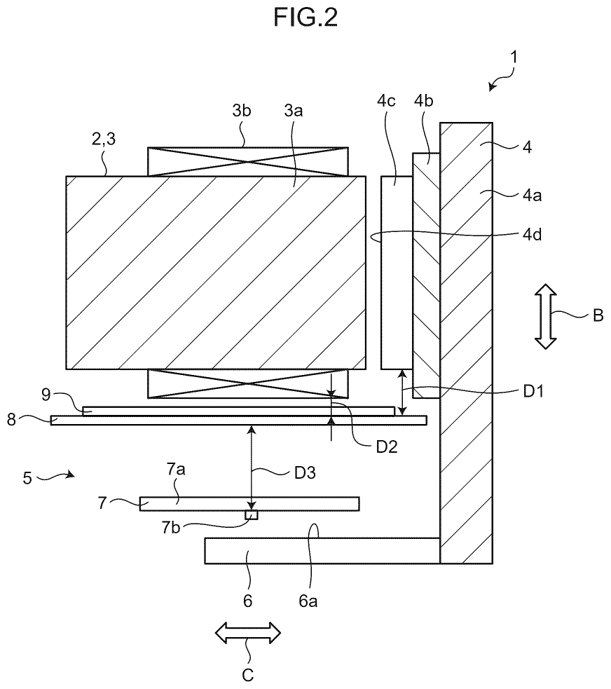

FIG. 1 is a plan view illustrating an entire linear conveyance system 1 according to a first embodiment. FIG. 2 is a sectional view illustrating the linear conveyance system 1 according to the first embodiment. The linear conveyance system 1 is a system that uses a linear Servomotor to convey articles. As illustrated in FIG. 1, the linear conveyance system 1 includes plural movers 4 and a conveyance path 2 that includes plural stators 3. As illustrated in FIG. 2, the linear conveyance system 1 also includes a position detector 5. Although not illustrated, the linear conveyance system 1 includes a control device that controls movement of the movers 4.

FIG. 2 illustrates a section perpendicular to conveyance directions, which are directions of movement of the movers 4 along the conveyance path 2. In the following description, the conveyance directions, which are the directions of movement of the movers 4 move along the conveyance path 2 and are the directions perpendicular to the sheet of FIG. 2, are referred to as the first directions A. Directions orthogonal to the first directions A are referred to as the second directions B. Directions orthogonal to the first directions A and the second directions B are referred to as the third directions C. In the following description, the second directions B are also defined as the vertical directions. In the following description, the second direction B is defined as including an upward direction toward the upper side of the drawing, and a downward direction toward the lower side of the drawing. For convenience of explanation, FIG. 2 hatches sections of a stator core 3a of the stator 3 and a housing 4a and a base 4b of the mover 4, all of which will be described later.

The conveyance path 2 illustrated in FIG. 1 is in a track-shape having straight and curved portions; however, the shape may be changed as appropriate. For example, the shape of the conveyance path 2 may be straight and curved, may be a different shape having a straight portion and a curved portion, or may be divided into plural paths at some point. As illustrated in FIG. 2, the conveyance path 2 includes the stator 3. Although not illustrated, the conveyance path 2 includes a base member and fittings, the base member holding the stators 3, position detection units 7 (described later), and magnetic shielding members 8 (described later), and the fittings being disposed between the base member and each of the stators 3, the position detection units 7, and the magnetic shielding members 8. During assembly of the conveyance path 2, the stators 3, the position detection units 7, and the magnetic shielding members 8 may be attached to the same fitting, and this fitting may then be attached to the base member.

Alternatively, during the assembly of the conveyance path 2, the stators 3 may be attached to one of the fittings, the position detection units 7 and the magnetic shielding members 8 may be attached to the other fitting, and the fittings may then be attached to the base member.

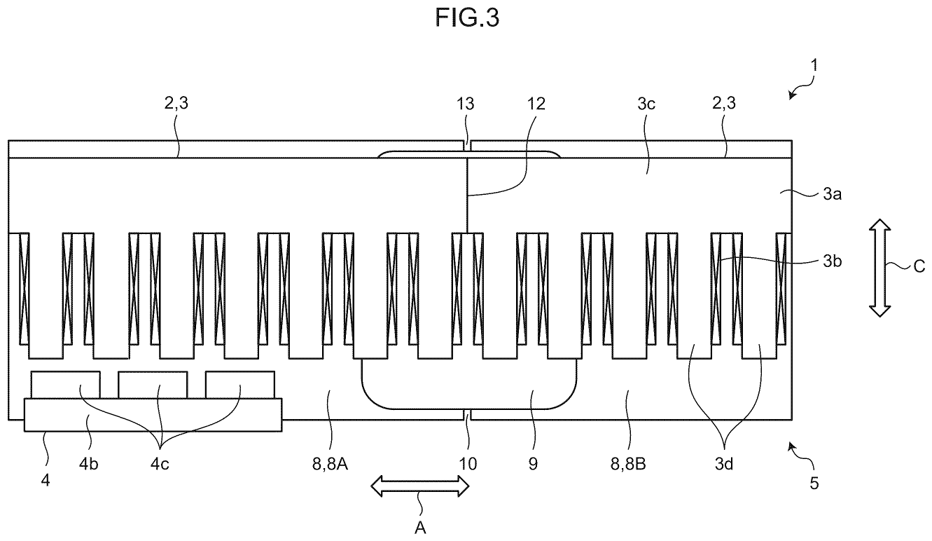

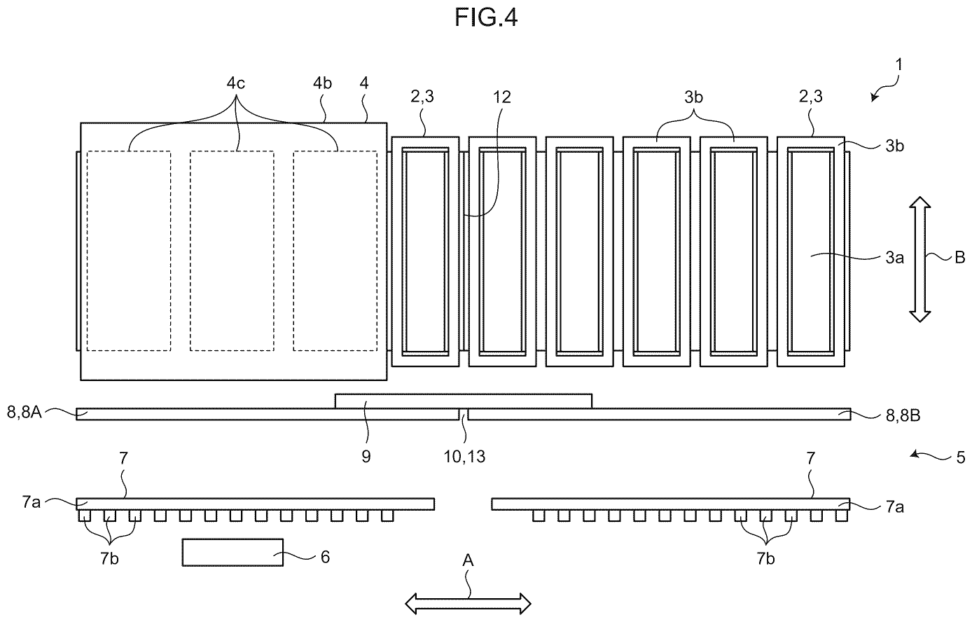

FIG. 3 is a plan view illustrating the linear conveyance system 1 according to the first embodiment. FIG. 4 is a side view illustrating the linear conveyance system 1 according to the first embodiment. As illustrated in FIG. 3, the stators 3 are divided in the first direction A. The stators 3 illustrated in the drawing are two in number; however, this example is not intended to limit the number of stators 3. The plural stators 3 are arranged and installed in the first direction A. The adjacent stators 3 are continuously arranged. Each stator 3 includes the stator core 3a and plural coils 3b.

The stator core 3 a includes a core back 3c and plural teeth 3d. The core back 3c extends in the first direction A. The plural teeth 3d protrude in the third direction C from an end of the core back 3c, the end facing the mover 4. The plural teeth 3d are arranged at intervals in the first direction A.

Each of the plural coils 3b is provided on the corresponding one of the plural teeth 3d. In other words, each of the plural coils 3b is formed of wires wound around the corresponding one of the plural teeth 3d.

The movers 4 are components that move along the conveyance path 2 and form the linear servomotor with the stators 3. As illustrated in FIG. 2, each mover 4 includes the housing 4a, the base 4b, and a moving magnet 4c.

The housing 4a is a plate-shaped member that holds the base 4b. The housing 4a extends in the second direction B. The housing 4a extends longer in the second direction B than the stators 3.

The base 4b is a plate-shaped member attached to a face of the housing 4a, the face facing the stator 3. The base 4b is disposed near one end of the housing 4a in the second direction B. The position of the base 4b and the position of the stator 3 in the second direction B are aligned. The base 4b faces the stator 3 in the third direction C. The base 4b extends in the second direction B.

The moving magnet 4c is a component that generates a magnetic field for moving the mover 4. The moving magnet 4c is, for example, a permanent magnet. The moving magnet 4c is attached to a face of the base 4b, the face facing the stator 3. The moving magnet 4c is attached to the housing 4a via the base 4b. A position of the moving magnet 4c and the position of the stator 3 in the second direction B are aligned. The moving magnet 4c faces the stator 3 in the third direction C and is disposed away from the stator 3 in the third direction C. The moving magnet 4c extends in the second direction B.

The moving magnet 4c includes a magnetic field generation face 4d where the magnetic field is generated. The magnetic field generation face 4d of the moving magnet 4c is the face that faces the stator 3 and extends in the second direction B in the present embodiment. The magnetic field generation face 4d is a plane surface orthogonal to the third directions C. An electric current flows through the coil 3b, thus generating a magnetic field. This magnetic field causes propulsive force to the moving magnet 4c, such that the mover 4 can move. As illustrated in FIG. 3, a plurality of the moving magnets 4c are attached to the single base 4b. The plural moving magnets 4c are arranged at intervals in the first direction A. The moving magnets 4c illustrated in the drawing are three in number; however, this example is not intended to limit the number of moving magnets 4c. The plural moving magnets 4c do not need to be arranged at intervals.

As illustrated in FIG. 2, the position detector 5 includes a position detection-specific magnet 6, the position detection unit 7, the magnetic shielding member 8, and a gap-specific magnetic shielding member 9. The position detector 5 is a device that detects a position of each mover 4.

The position detection-specific magnet 6 is a magnet that generates a magnetic field for detecting the position of the mover 4. The position detection-specific magnet 6 is, for example, a scale magnet with plural magnetic poles. The position detection-specific magnet 6 is installed on the mover 4. The position detection-specific magnet 6 is attached to the face of the housing 4a, the face facing the stator 3. The position detection-specific magnet 6 is positioned near an opposite end of the housing 4a in the second direction B, the opposite end being opposite to the end near which the base 4b is disposed. The position detection-specific magnet 6 is disposed away from the stator 3 in the second direction B. The position detection-specific magnet 6 is disposed away from the moving magnet 4c in the second direction B. The position detection-specific magnet 6 extends in the third direction C.

The position detection-specific magnet 6 includes a magnetic field generation face 6a where the magnetic field is generated. The magnetic field generation face 6a of the position detection-specific magnet 6 faces the position detection unit 7 and extends in the third direction C in the present embodiment. The magnetic field generation face 6a is a plane surface orthogonal to the second directions B. The magnetic field generation face 4d of the moving magnet 4c and the magnetic field generation face 6a of the position detection-specific magnet 6 are orthogonal to each other.

The position detection unit 7 is installed on the conveyance path 2 and detects the magnetic field generated by the position detection-specific magnet 6. The position detection unit 7 is disposed between the stator 3 and the position detection-specific magnet 6 in the second direction B. The position detection unit 7 is disposed away from the stator 3 in the second direction B. The position detection unit 7 is disposed away from the moving magnet 4c in the second direction B.

As illustrated in FIG. 4, the plural position detection units 7 are arranged at intervals in the first direction A. The position detection units 7 illustrated in the drawing are two in number; however, this example is not intended to limit the number of position detection units 7. Each position detection unit 7 includes a substrate 7a and plural magnetic sensors 7b attached to the substrate 7a. The magnetic sensors 7b are, for example, magnetoresistive elements or Hall elements. The plural magnetic sensors 7b are arranged at intervals in the first direction A. Each magnetic sensor 7b is attached to a face of the substrate 7a, the face facing the position detection-specific magnet 6. As illustrated in FIG. 2, the positions of the position detection-specific magnet 6 and the magnetic sensor 7b in the third direction C are aligned. The magnetic sensor 7b faces the position detection-specific magnet 6 in the second direction B. The magnetic sensor 7b is disposed away from the position detection-specific magnet 6 in the second direction B.

As illustrated in FIG. 4, the magnetic shielding members 8 are divided in the first direction A. The magnetic shielding members 8 illustrated in the drawing are two in number; however, this example is not intended to limit the number of magnetic shielding members 8. The plural magnetic shielding members 8 are arranged and installed with a gap 10 in the first direction A, providing a shield against magnetic flux heading from the moving magnets 4c of the mover 4 and the coils 3b of the stator 3 to the position detection unit(s) 7. A material of the magnetic shielding members 8 is, for example, a magnetic material. Examples of the magnetic material include a cold-rolled steel sheet, a sheet of carbon steel such as S45C, and an electrical steel sheet. Each magnetic shielding member 8 extends in the first direction A. In the present embodiment, each magnetic shielding member 8 is a plate-shaped member longer in the first direction A than in the second direction B. The magnetic shielding members 8 are disposed between the moving magnets 4c and the position detection units 7 in the second direction B and are disposed between the stators 3 and the position detection units 7 in the second direction B.

In the illustrated example, a boundary position 12 of the adjacent stators 3 in the first direction A and a boundary position 13 of the adjacent magnetic shielding members 8 in the first direction A are aligned but may be out of alignment. To distinguish the adjacent magnetic shielding members 8 in the following description, one magnetic shielding member 8 is referred to as the magnetic shielding member 8A, and the other magnetic shielding member 8 is referred to as the magnetic shielding member 8B.

It is preferable that the plural magnetic shielding members 8 are arranged and installed without gaps in the first direction A. However, when the plural stators 3 are arranged and installed without gaps in the first direction A, in practice, the gap 10 occurs between the adjacent magnetic shielding members 8 because of inevitable dimensional and assembly tolerances and a gap intentionally provided to avoid any problems caused by interference, etc. This gap 10 varies in size, ranging from a large one to a small one unnoticeable at first sight. For convenience of explanation, the gap 10 is illustrated larger here. The same applies to what follows.

The gap-specific magnetic shielding member 9 is a member that closes the gap 10 between the adjacent magnetic shielding members 8 to provide a shield against the magnetic flux heading from the moving magnets 4c and the coils 3b to the position detection unit(s) 7. More specifically, the gap-specific magnetic shielding member 9 is the member that provides the shield against the magnetic flux heading from the moving magnets 4c and the coils 3b to the position detection unit(s) 7 through the gap 10. A material of the gap-specific magnetic shielding member 9 is, for example, a magnetic material. Examples of the magnetic material include a cold-rolled steel sheet, a sheet of carbon steel such as S45C, and an electrical steel sheet. In the present embodiment, the gap-specific magnetic shielding member 9 is formed separately from the magnetic shielding members 8. The gap-specific magnetic shielding member 9 extends in the first direction A. The gap-specific magnetic shielding member 9 is the plate-shaped member longer in the first direction A than in the second direction B.

The gap-specific magnetic shielding member 9 lies astride the gap 10 and is in contact with the two magnetic shielding members 8 adjacent to each other. For example, the gap-specific magnetic shielding member 9 is screwed to the magnetic shielding members 8. The magnetic shielding members 8 and the gap-specific magnetic shielding member 9 may have the same thickness or different thicknesses. The material of the magnetic shielding members 8 and the material of the gap-specific magnetic shielding member 9 may be the same or different.

With reference to FIG. 2, a detailed description is provided of how the magnetic shielding members 8, the moving magnets 4c, the stators 3, and the position detection units 7 are arranged. A distance D1 is defined as the distance between the magnetic shielding member 8 and the moving magnet 4c along the second direction B. Specifically, the distance D1 is the distance from a closer side of the moving magnet 4c to the magnetic shielding member 8 in the second direction B to the magnetic shielding member 8. A distance D2 is defined as the distance between the magnetic shielding member 8 and the stator 3 along the second direction B. Specifically, the distance D2 is the distance from a closer side of the stator 3 to the magnetic shielding member 8 in the second direction B to the magnetic shielding member 8. A distance D3 is defined as the distance between the magnetic shielding member 8 and the position detection unit 7 along the second direction B. Specifically, the distance D3 is the distance between the magnetic shielding member 8 and the magnetic sensor 7b of the position detection unit 7 along the second direction B. In the present embodiment, the magnetic shielding members 8, the moving magnets 4c, the stators 3, and the position detection units 7 are arranged to satisfy both a condition that the distance D1 is shorter than the distance D3 and a condition that the distance D2 is shorter than the distance D3. The magnetic shielding members 8, the moving magnets 4c, the stators 3, and the position detection units 7 may be arranged to satisfy at least one of the condition that the distance D1 is shorter than the distance D3 or the condition that the distance D2 is shorter than the distance D3.

Next, a description is provided of effects of the linear conveyance system 1 according to the present embodiment.

As illustrated in FIG. 4, the linear conveyance system 1 of the present embodiment includes the gap-specific magnetic shielding member 9 that closes the gap 10 between the adjacent magnetic shielding members 8 and is capable of providing a shield against the magnetic flux heading from the moving magnets 4c and the coils 3b to the position detection unit(s) 7. This configuration can prevent the magnetic flux generated by the moving magnets 4c and the coils 3b from heading to the position detection unit(s) 7 through the gap 10. As a result, this configuration can restrain the magnetic flux generated by the moving magnets 4c and the coils 3b from interfering with the position detection unit(s) 7 through the gap 10, and thus enable improved accuracy of position detection of each mover 4 compared to a conventional configuration.

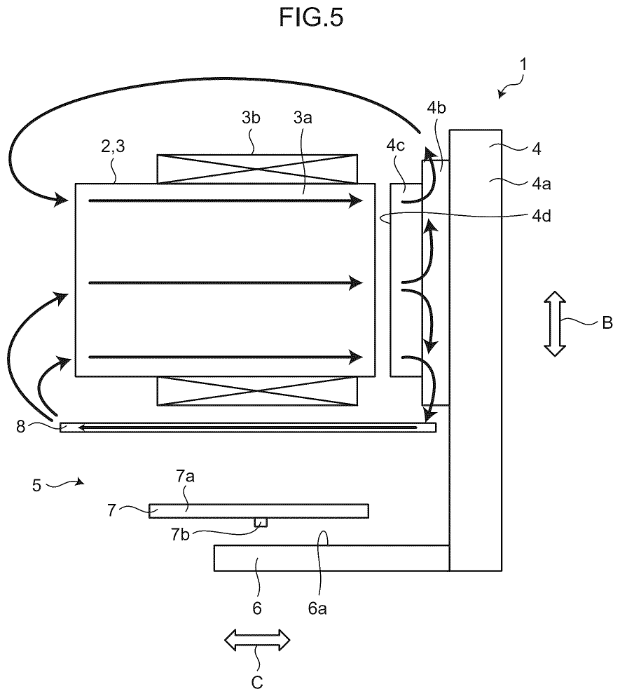

FIG. 5 is an explanatory diagram illustrating an effect of the linear conveyance system 1 according to the first embodiment. In FIG. 5, solid arrows indicate a magnetic flux generated by the moving magnet 4c and the coil 3b. In FIG. 5, the gap-specific magnetic shielding member 9 is not illustrated for convenience of explanation. In the present embodiment, as illustrated in FIG. 5, the stator 3 is disposed away from the position detection-specific magnet 6 in the second direction B, and the position detection unit 7 is disposed between the stator 3 and the position detection-specific magnet 6 in the second direction B. Furthermore, in the present embodiment, the magnetic shielding member 8 is disposed between the stator 3 and the position detection unit 7 in the second direction B. These configurations allow the magnetic flux generated by the coil 3b and the moving magnet 4c to return to the stator core 3a through the magnetic shielding member 8.

Specifically, a magnetic flux generated by the coil 3b when the coil 3b is energized flows through the moving magnet 4c and then to the base 4b. Furthermore, when the coil 3b is energized, a magnetic flux generated by the moving magnet 4c flows into the base 4b. Next, a resultant magnetic flux flowing into the base 4b splits into one that takes a route to the magnetic shielding member 8 and the other that takes a route leading away from the magnetic shielding member 8 in the second direction B. The magnetic flux heading from the base 4b to the magnetic shielding member 8 flows along the magnetic shielding member 8 and then returns to the stator core 3a from an end of the stator core 3a, the end facing in a direction opposite to the mover 4. The magnetic flux heading from the base 4b away from the magnetic shielding member 8 in the second direction B passes around the stator 3 and then returns to the stator core 3a from the end of the stator core 3a, the end facing in the direction opposite to the mover 4. This further reduces the interference of the magnetic flux generated by the moving magnets 4c and the coils 3b with the position detection unit(s) 7, and thus enables a further improvement in the accuracy of position detection of each mover 4.

In the present embodiment, as illustrated in FIG. 2, the moving magnet 4c is disposed away from the position detection unit 7 in the second direction B, and the stator 3 is disposed away from the position detection unit 7 in the second direction B. Furthermore, in the present embodiment, the magnetic shielding member 8 is disposed between the moving magnet 4c and the position detection unit 7 in the second direction B and is disposed between the stator 3 and the position detection unit 7 in the second direction B. Furthermore, in the present embodiment, the magnetic shielding members 8, the moving magnets 4c, the stators 3, and the position detection units 7 are arranged to satisfy both the condition that the distance D1 is shorter than the distance D3 and the condition that the distance D2 is shorter than the distance D3. These configurations can further enhance the effect of returning the magnetic flux generated by the coil 3b and the moving magnet 4c to the stator core 3a through the magnetic shielding member 8. This further reduces the interference of the magnetic flux generated by the moving magnets 4c and the coils 3b with the position detection unit(s) 7, and thus enables a further improvement in the accuracy of position detection of each mover 4.

In the present embodiment, as illustrated in FIG. 2, the magnetic field generation face 4d of the moving magnet 4c and the magnetic field generation face 6a of the position detection-specific magnet 6 are orthogonal to each other. This configuration makes it less likely that the magnetic flux generated by the moving magnet 4c interferes with the position detection unit 7, and thus allows for a further improvement in the accuracy of position detection of the mover 4.

### Second Embodiment

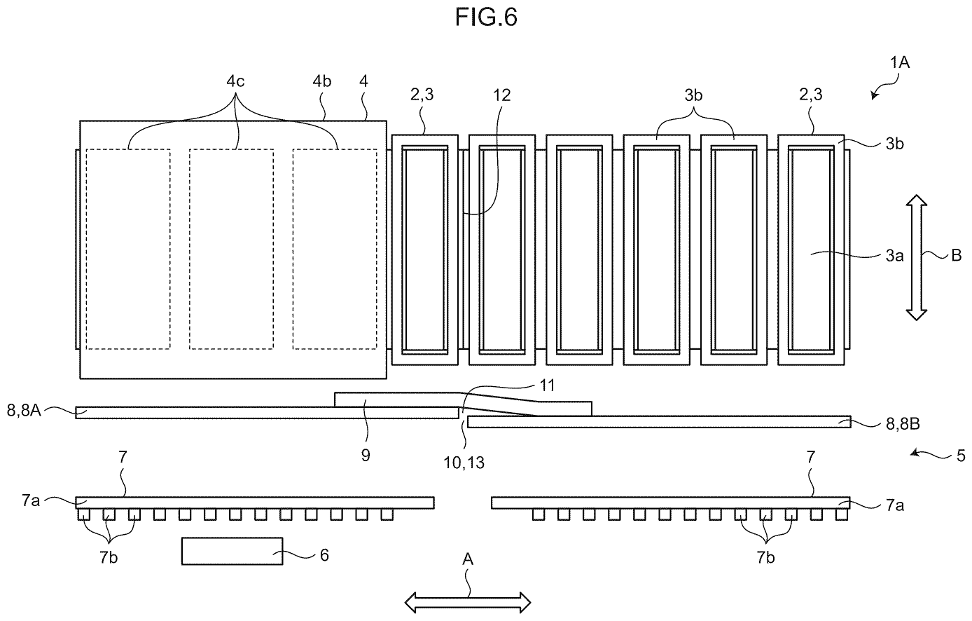

Next, with reference to FIG. 6, a description is provided of a linear conveyance system 1A according to a second embodiment. FIG. 6 is a side view illustrating the linear conveyance system 1A according to the second embodiment. In the present embodiment, the gap-specific magnetic shielding member 9 is configured differently from that of the first embodiment described above. The second embodiment overlaps the first embodiment described above, and those overlapping parts have the same reference characters and are not described.

It is preferable that adjacent magnetic shielding members 8 have their aligned positions in the second direction B. In practice, however, a level difference 11 may occur between the adjacent magnetic shielding members 8 because of dimensional and assembly tolerances of the magnetic shielding members 8 and an intended shift thereof intended to avoid any problems caused by interference of the magnetic shielding members 8, etc. This level difference 11 varies in magnitude, ranging from a significant one to a slight one unnoticeable at first sight. For convenience of explanation, the level difference 11 is illustrated larger herein. The positions of the adjacent magnetic shielding members 8 in the second direction B are out of alignment. In the present embodiment, the magnetic shielding member 8A is disposed closer to the stators 3 than the other magnetic shielding member 8B is. The level difference 11 occurs between the adjacent magnetic shielding members 8A and 8B offset in the second direction B. The gap-specific magnetic shielding member 9 bends along the level difference 11 and is in contact with the adjacent magnetic shielding members 8A and 8B.

Next, a description is provided of an effect of the linear conveyance system 1A according to the present embodiment.

In the present embodiment, the level difference 11 is formed between the adjacent magnetic shielding members 8A and 8B offset in the second direction B, and the gap-specific magnetic shielding member 9 bends along the level difference 11 and is in contact with the adjacent magnetic shielding members 8A and 8B. This configuration can eliminate a magnetic gap between the magnetic shielding members 8A and 8B and the gap-specific magnetic shielding member 9 even when the level difference 11 occurs between the adjacent magnetic shielding members 8A and 8B. In other words, since the gap-specific magnetic shielding member 9 is bent suitably along the level difference 11 between the adjacent magnetic shielding members 8A and 8B and is contact with the adjacent magnetic shielding members 8A and 8B, the magnetic gap between the magnetic shielding members 8A and 8B and the gap-specific magnetic shielding member 9 can be eliminated. This restrains magnetic flux generated by the moving magnets 4c and the coils 3b from interfering with the position detection unit(s) 7, and enables improved accuracy of position detection of each mover 4 compared to a conventional configuration even when the level difference 11 occurs between the adjacent magnetic shielding members 8A and 8B.

### Third Embodiment

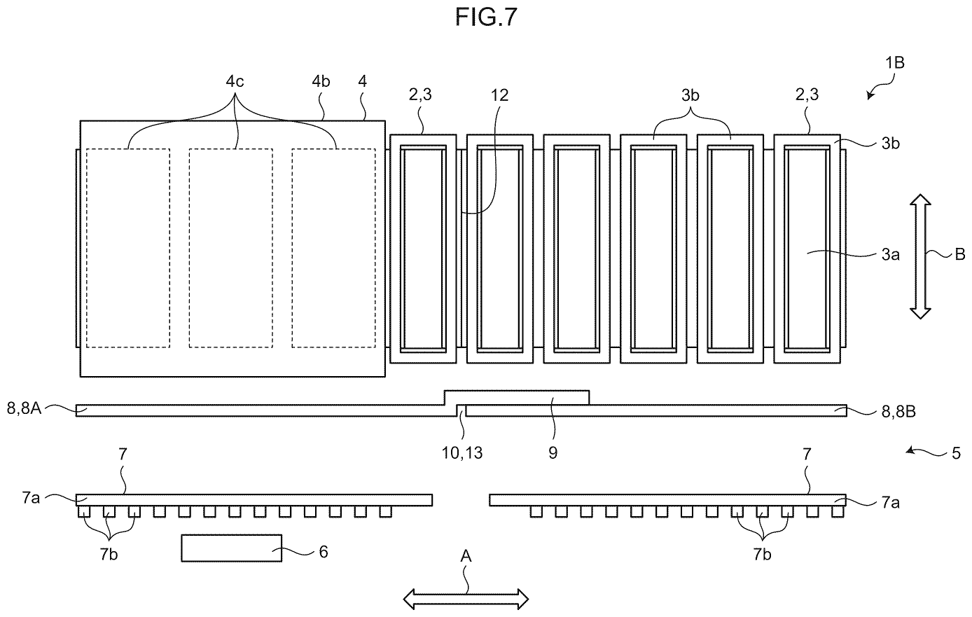

Next, with reference to FIG. 7, a description is provided of a linear conveyance system 1B according to a third embodiment. FIG. 7 is a side view illustrating the linear conveyance system 1B according to the third embodiment. In the present embodiment, the gap-specific magnetic shielding member 9 is configured differently from that of the first embodiment described above. The third embodiment overlaps the first embodiment described above, and those overlapping parts have the same reference characters and are not described.

The gap-specific magnetic shielding member 9 is formed integrally with one of the adjacent magnetic shielding members 8. The gap-specific magnetic shielding member 9 extends, toward the stator 3, from an end of the magnetic shielding member 8A, the end facing the other magnetic shielding member 8B, and then extends toward the other magnetic shielding member 8B. The gap 10 is closed by the gap-specific magnetic shielding member 9 on a side closer to the stators 3. The gap-specific magnetic shielding member 9 is in contact with a face of the other magnetic shielding member 8B, the face facing the stator 3.

The gap-specific magnetic shielding member 9 may extend, toward the position detection unit 7, from the end of the magnetic shielding member 8A, the end facing the other magnetic shielding member 8B, and then extend toward the other magnetic shielding member 8B. In the case of such a configuration, the gap 10 is closed by the gap-specific magnetic shielding member 9 on a side closer to the position detection units 7, and the gap-specific magnetic shielding member 9 is in contact with a face of the other magnetic shielding member 8B, the face facing the position detection unit 7. The gap-specific magnetic shielding member 9 may be formed on the other magnetic shielding member 8B.

Next, a description is provided of effects of the linear conveyance system 1B according to the present embodiment.

In the present embodiment, the gap-specific magnetic shielding member 9 is formed integrally with the one of the adjacent magnetic shielding members 8. This configuration enables a reduced number of components and, as in the first embodiment described above, improved accuracy of position detection of each mover 4 compared to the conventional configuration.

### Fourth Embodiment

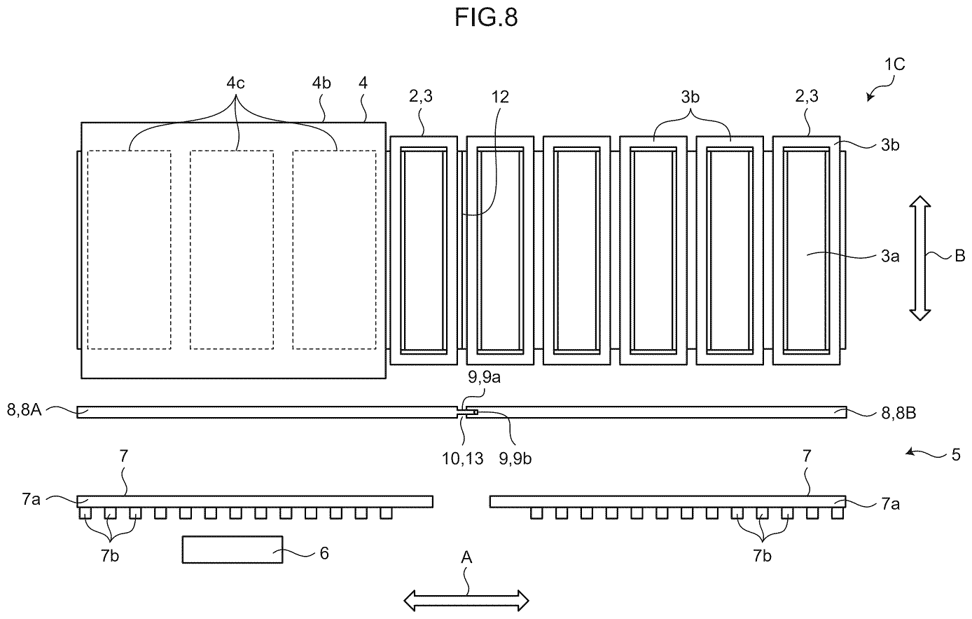

Next, with reference to FIG. 8, a description is provided of a linear conveyance system 1C according to a fourth embodiment. FIG. 8 is a side view illustrating the linear conveyance system IC according to the fourth embodiment. In the present embodiment, the gap-specific magnetic shielding member 9 is configured differently from that of the first embodiment described above. The fourth embodiment overlaps the first embodiment described above, and those overlapping parts have the same reference characters and are not described.

The gap-specific magnetic shielding member 9 includes a first shielding part 9a extending from one of the magnetic shielding members 8 toward the other magnetic shielding member 8, and a second shielding part 9b that is formed on the other magnetic shielding member 8 and is in contact with the first shielding part 9a. The first shielding part 9a extends, toward the magnetic shielding member 8B, from an end of the magnetic shielding member 8A, the end facing the other magnetic shielding member 8B. In the present embodiment, the first shielding part 9a is a protruding part.

The second shielding part 9b is formed on an end of the magnetic shielding member 8B, the end facing the magnetic shielding member 8A. In the present embodiment, the second shielding part 9b is a recessed part into which the first shielding part 9a is inserted. The recessed part opens toward the magnetic shielding member 8A. The recessed part is indented in a direction away from the magnetic shielding member 8A. The recessed part serving as the second shielding part 9b is in contact with the protruding part serving as the first shielding part 9a, at an inner surface. The gap 10 is closed by the insertion of the first shielding part 9a into the second shielding part 9b.

The first shielding part 9a may be the recessed part, with the second shielding part 9b being the protruding part inserted into the recessed part.

Next, a description is provided of effects of the linear conveyance system 1C according to the present embodiment.

In the present embodiment, the gap-specific magnetic shielding member 9 is formed integrally with both of the adjacent magnetic shielding members 8. This configuration enables a reduced number of components and, as in the first embodiment described above, improved accuracy of position detection of each mover 4 compared to the conventional configuration.

In the present embodiment, the gap-specific magnetic shielding member 9 includes the first shielding part 9a that extends from the one of the adjacent magnetic shielding members 8 toward the other magnetic shielding member 8, and the second shielding part 9b that is formed on the other magnetic shielding member 8 and is in contact with the first shielding part 9a. Specifically, the first shielding part 9a is the protruding part extending from the magnetic shielding member 8A toward the magnetic shielding member 8B. The second shielding part 9b is the recessed part formed on the magnetic shielding member 8B, and the protruding part serving as the first shielding part 9a is inserted into the second shielding part 9b. This configuration can eliminate or reduce the gap 10 between the adjacent magnetic shielding members 8A and 8B.

### Fifth Embodiment

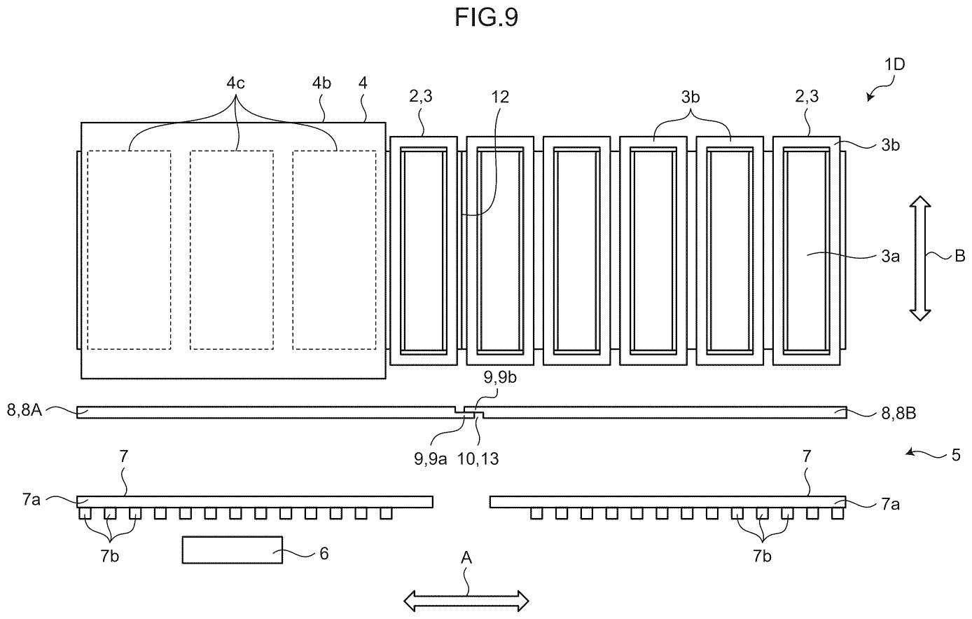

Next, with reference to FIG. 9, a description is provided of a linear conveyance system 1D according to a fifth embodiment. FIG. 9 is a side view illustrating the linear conveyance system 1D according to the fifth embodiment. In the present embodiment, the gap-specific magnetic shielding member 9 is configured differently from that of the first embodiment described above. The fifth embodiment overlaps the first embodiment described above, and those overlapping parts have the same reference characters and are not described.

The gap-specific magnetic shielding member 9 includes a first shielding part 9a extending from one of the adjacent magnetic shielding members 8 toward the other magnetic shielding member 8, and a second shielding part 9b that is formed on the other magnetic shielding member 8 and is in contact with the first shielding part 9a. The first shielding part 9a extends, toward the magnetic shielding member 8B, from an end of the magnetic shielding member 8A, the end facing the other magnetic shielding member 8B. In the present embodiment, the first shielding part 9a is a protruding part. The first shielding part 9a extends, toward the magnetic shielding member 8B, from a lower half of the end of the magnetic shielding member 8A, the end facing the other magnetic shielding member 8B.

The second shielding part 9b is formed on an end of the magnetic shielding member 8B, the end facing the magnetic shielding member 8A. In the present embodiment, the second shielding part 9b is a protruding part. The second shielding part 9b extends, toward the magnetic shielding member 8A, from an upper half of the end of the magnetic shielding member 8B, the end facing the magnetic shielding member 8A. The first and second shielding parts 9a and 9b have their aligned positions in the first direction A. The first and second shielding parts 9a and 9b overlap each other in the second direction B. In other words, the first and second shielding parts 9a and 9b are located overlapping each other when viewed in the second direction B. The second shielding part 9b is in contact with a face of the first shielding part 9a, the face facing the stators 3.

In the present embodiment, the second shielding part 9b may be in contact with a face of the first shielding part 9a, the face facing the position detection units 7.

Next, a description is provided of effects of the linear conveyance system 1D according to the present embodiment.

In the present embodiment, the gap-specific magnetic shielding member 9 is formed integrally with both of the adjacent magnetic shielding members 8. This configuration enables a reduced number of components and, as in the first embodiment described above, improved accuracy of position detection of each mover 4 compared to the conventional configuration.

In the present embodiment, the gap-specific magnetic shielding member 9 includes the first shielding part 9a that extends from the one of the adjacent magnetic shielding members 8 toward the other magnetic shielding members 8, and the second shielding part 9b that is formed on the other magnetic shielding member 8 and is in contact with the first shielding part 9a. Specifically, the first shielding part 9a is the protruding part extending from the magnetic shielding member 8A toward the magnetic shielding member 8B. The second shielding part 9b is the protruding part extending from the magnetic shielding member 8B toward the magnetic shielding member SA and located overlapping the first shielding part 9a when viewed in the second direction B. This configuration can eliminate or reduce the gap 10 between the adjacent magnetic shielding members 8A and 8B.

### Sixth Embodiment

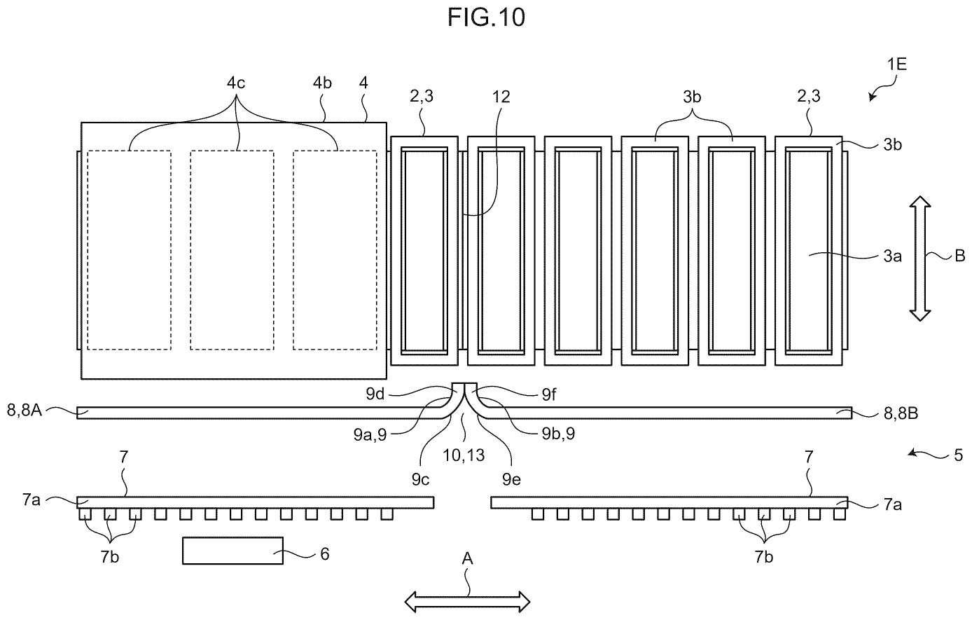

Next, with reference to FIG. 10, a description is provided of a linear conveyance system 1E according to a sixth embodiment. FIG. 10 is a side view illustrating the linear conveyance system 1E according to the sixth embodiment. In the present embodiment, the gap-specific magnetic shielding member 9 is configured differently from that of the first embodiment described above. The sixth embodiment overlaps the first embodiment described above, and those overlapping parts have the same reference characters and are not described.

The gap-specific magnetic shielding member 9 includes a first shielding part 9a extending from one of the adjacent magnetic shielding members 8 toward the other magnetic shielding member 8, and a second shielding part 9b that is formed on the other magnetic shielding member 8 and is in contact with the first shielding part 9a.

The first shielding part 9a extends, toward the magnetic shielding member 8B, from an end of the magnetic shielding member 8A, the end facing the other magnetic shielding member 8B. The first shielding part 9a curves closer to the stator 3 as the first shielding part 9a heads from the magnetic shielding member 8A toward the magnetic Shielding member 8B. The first shielding part 9a includes a first bent part 9c and a first contact part 9d. The first bent part 9c is a curved part formed between the first contact part 9d and the end of the magnetic shielding member 8A, the end facing the other magnetic shielding member 8B. The first contact part 9d extends closer to the stator 3 in a curved shape as the first contact part 9d heads from the first bent part 9c toward the magnetic shielding member 8B. The first contact part 9d is elastically deformable in the first direction A about the first bent part 9c.

The second shielding part 9b extends, toward the magnetic shielding member 8A, from an end of the magnetic shielding member 8B, the end facing the magnetic shielding member 8A. The second shielding part 9b curves closer to the stator 3 as the second shielding part 9b heads from the magnetic shielding member 8B toward the magnetic shielding member 8A. The first shielding part 9a and the second shielding part 9b are in a symmetrical form in the first direction A. The second shielding part 9b includes a second bent part 9e and a second contact part 9f. The second bent part 9e is a curved part formed between the second contact part 9f and the end of the magnetic shielding member 8B, the end facing the magnetic shielding member 8A. The second contact part Of extends closer to the stator 3 in a curved shape as the second contact part Of heads from the second bent part 9e toward the magnetic shielding member 8A. The second contact part of is elastically deformable in the first direction A about the second bent part 9e.

When a leading end of the first contact part 9d contacts a leading end of the second contact part 9f during assembly of the magnetic shielding members 8 formed integrally with the gap-specific magnetic shielding member 9, the first contact part 9d is elastically deformed in a direction away from the second contact part Of about a boundary part between the first contact part 9d and the first bent part 9c and then pressed against the second contact part 9f under the action of elastic restoring force of the boundary part. On the other hand, when the leading end of the second contact part Of contacts the leading end of the first contact part 9d during the assembly of the magnetic shielding members 8 formed integrally with the gap-specific magnetic shielding member 9, the second contact part 9f is elastically deformed in a direction away from the first contact part 9d about a boundary part between the second contact part 9f and the second bent part 9e and then pressed against the first contact part 9d under the action of elastic restoring force of the boundary part. The first and second shielding parts 9a and 9b press each other in their contact relation, thus closing the gap 10.

The first shielding part 9a may curve closer to the position detection unit 7 as the first shielding part 9a heads toward the magnetic shielding member 8B. The second shielding part 9b may curve closer to the position detection unit 7 as the second shielding part 9b heads toward the magnetic shielding member 8A.

Next, a description is provided of effects of the linear conveyance system 1E according to the present embodiment.

In the present embodiment, the gap-specific magnetic shielding member 9 is formed integrally with both of the adjacent magnetic shielding members 8. This configuration enables a reduced number of components and, as in the first embodiment described above, improved accuracy of position detection of each mover 4 compared to the conventional configuration.

In the present embodiment, the gap-specific magnetic shielding member 9 includes the first shielding part 9a that extends from the one of the adjacent magnetic shielding members 8 toward the other magnetic shielding member 8, and the second shielding part 9b that is formed on the other magnetic shielding member 8 and is in contact with the first shielding part 9a. Specifically, the first and second shielding parts 9a and 9b have the elastic restoring forces, pressing each other in their contact relation. This configuration can eliminate or reduce the gap 10 between the adjacent magnetic shielding members 8A and 8B.

Furthermore, since the first and second shielding parts 9a and 9b have the elastic restoring forces and in contact pressing each other in the present embodiment. Thus, even if the level difference 11 illustrated in FIG. 6 is present between the adjacent magnetic shielding members 8A and 8B, the first and second shielding parts 9a and 9b will be in contact with each other in elastic deformation suitable for the level difference 11. Consequently, a magnetic gap between the first shielding part 9a and the second shielding part 9b can be eliminated. This restrains magnetic flux generated by the moving magnets 4c and the coils 3b from interfering with the position detection unit(s) 7 even if the level difference 11 occurs between the adjacent magnetic shielding members 8A and 8B, and enables improved accuracy of position detection of each mover 4 compared to a conventional configuration.

The above configurations illustrated in the embodiments are illustrative, can be combined with other techniques that are publicly known, and can be partly omitted or changed without departing from the gist. The embodiments can be combined with each other.

### REFERENCE SIGNS LIST

1, 1A, 1B, 1C, 1D, 1E linear conveyance system; 2 conveyance path; 3 stator; 3a stator core; 3b coil; 3c core back; 3d tooth; 4 mover; 4 a housing; 4 b base; 4c moving magnet; 4d, 6a magnetic field generation face; 5 position detector; 6 position detection-specific magnet; 7 position detection unit; 7a substrate; 7b magnetic sensor; 8, 8A, 8B magnetic shielding member; 9 gap-specific magnetic shielding member; 9a first shielding part; 9b second shielding part; 9c first bent part; 9d first contact part; 9e second bent part; 9f second contact part; 10 gap; 11 level difference; 12, 13 boundary position; A first direction; B second direction; C third direction.

1. A position detector comprising:
a position detection-specific magnet installable on a mover to move along a conveyance path including a stator;
a position detection sensor installable on the conveyance path to detect a magnetic field generated by the position detection-specific magnet;
a plurality of magnetic shielding members arrangeable and installable with a gap in a first direction that is a direction of movement of the mover along the conveyance path, the magnetic shielding members being capable of providing a shield against magnetic flux heading from a moving magnet of the mover and coils of the stator to the position detection sensor; and
a gap-specific magnetic shielding member closing the gap between adjacent ones of the magnetic shielding members, the gap-specific magnetic shielding member being capable of providing a shield against the magnetic flux.

2. The position detector according to claim 1, wherein
a level difference is formed between the adjacent magnetic shielding members offset in a second direction that is a direction orthogonal to the first direction, and
the gap-specific magnetic shielding member bends along the level difference and is in contact with the adjacent magnetic shielding members.

3. The position detector according to claim 1, wherein
the position detection-specific magnet capable of being disposed away from the stator in a second direction that is a direction orthogonal to the first direction,
the position detection sensor is capable of being disposed between the stator and the position detection-specific magnet in the second direction, and
the magnetic shielding members are capable of being disposed between the stator and the position detection sensor in the second direction.

4. The position detector according to claim 1 wherein
the magnetic shielding members are capable of being disposed between the moving magnet and the position detection sensor disposed away from the moving magnet in a second direction, the magnetic shielding members being capable of being disposed between the stator and the position detection sensor disposed away from the stator in the second direction, the second direction being a direction orthogonal to the first direction, and
the magnetic shielding members, the moving magnet, the stator, and the position detection sensor are arrangeable to satisfy at least one of a condition that a distance between the magnetic shielding members and the moving magnet along the second direction is shorter than a distance between the magnetic shielding members and the position detection sensor along the second direction or a condition that a distance between the magnetic shielding members and the stator along the second direction is shorter than a distance between the magnetic shielding members and the position detection sensor along the second direction.

5. The position detector according to claim 1, wherein the gap-specific magnetic shielding member is formed integrally with at least one of the adjacent magnetic shielding members.

6. The position detector according to claim 1, wherein the gap-specific magnetic shielding member includes
a first shielding part extending from one of the adjacent magnetic shielding members toward the other magnetic shielding member and
a second shielding part formed on the other magnetic shielding member, the second shielding part being in contact with the first shielding part.

7. A linear conveyance system comprising:
a conveyance path including a stator;
a mover to move along the conveyance path, the mover forming a linear servomotor with the stator;
a position detection-specific magnet installed on the mover;
a position detection sensor installed on the conveyance path to detect a magnetic field generated by the position detection-specific magnet;
a plurality of magnetic shielding members arranged and installed with a gap in a first direction that is a direction of movement of the mover along the conveyance path, the plurality of magnetic shielding members being capable of providing a shield against magnetic flux heading from a moving magnet of the mover and coils of the stator to the position detection sensor; and
a gap-specific magnetic shielding member closing the gap between adjacent ones of the magnetic shielding members, the gap-specific magnetic shielding member being capable of providing a shield against the magnetic flux.

8. The linear conveyance system according to claim 7, wherein
a level difference is formed between the adjacent magnetic shielding members offset in a second direction that is a direction orthogonal to the first direction, and
the gap-specific magnetic shielding member bends along the level difference and is in contact with the adjacent magnetic shielding members.

9. The linear conveyance system according to claim 7, wherein
the position detection-specific magnet is disposed away from the stator in a second direction that is a direction orthogonal to the first direction,
the position detection sensor is disposed between the stator and the position detection-specific magnet in the second direction, and
the magnetic shielding members are disposed between the stator and the position detection sensor in the second direction.

10. The linear conveyance system according to claim 7, wherein
the position detection sensor is disposed away from the moving magnet in a second direction that is a direction orthogonal to the first direction,
the position detection sensor is disposed away from the stator in the second direction,
the magnetic shielding members are positioned between the moving magnet and the position detection sensor in the second direction and are positioned between the stator and the position detection sensor in the second direction, and
the magnetic shielding members, the moving magnet, the stator, and the position detection sensor are arranged, satisfying at least one of a condition that a distance between the magnetic shielding members and the moving magnet along the second direction is shorter than a distance between the magnetic shielding members and the position detection sensor along the second direction or a condition that a distance between the magnetic shielding members and the stator along the second direction is shorter than a distance between the magnetic shielding members and the position detection sensor along the second direction.

11. The linear conveyance system according to claim 7, wherein a magnetic field generation face of the moving magnet and a magnetic field generation face of the position detection-specific magnet are orthogonal to each other.

12. The linear conveyance system according to claim 7, wherein the gap-specific magnetic shielding member is formed integrally with at least one of the adjacent magnetic shielding members.

13. The linear conveyance system according to claim 7, wherein the gap-specific magnetic shielding member includes
a first shielding part extending from one of the adjacent magnetic shielding members toward the other magnetic shielding member and
a second shielding part formed on the other magnetic shielding member, the second shielding part being in contact with the first shielding part.
